(19) United States
(12) Patent Application Publication
(10) Pub. No.: US 2022/0414059 A1
(43) Pub. Date: Dec. 29, 2022

(54) KEY-VALUE STORAGE DEVICE, HOST, AND HOST-STORAGE SYSTEM

(71) Applicant: SAMSUNG ELECTRONICS CO., LTD., Suwon-si (KR)

(72) Inventors: Sungjin LEE, Daegu (KR); Jinhyung KOO, Daegu (KR); Junsu IM, Daegu (KR); Juhyung PARK, Daegu (KR)

(73) Assignee: DAEGU GYEONGBUK INSTITUTE OF SCIENCE AND TECHNOLOGY, Daegu (KR)

(21) Appl. No.: 17/807,933

(22) Filed: Jun. 21, 2022

(30) Foreign Application Priority Data
Jun. 24, 2021 (KR) 10-2021-0082336
Mar. 21, 2022 (KR) 10-2022-0034937

(51) Int. Cl. G06F 16/17

(52) U.S. Cl. CPC G06F 16/17

(57) ABSTRACT

A host communicating with a key-value storage device includes a host memory that stores a computer program, and a host controller including a processor configured to execute the computer program. The computer program is configured to process a file or a directory related to file data received by an application stored in the host, and provide the file or the directory to the key-value storage device, map the file or the directory to a key-value object storable in the key-value storage device, translate a file operation requested by the application stored in the host into a key-value operation that is performable in the key-value storage device, manage a transaction related to the key-value object and the key-value operation and provide the transaction to the key-value storage device, and abstract the file or the directory into a meta-object or a data object.

### CROSS-REFERENCE TO RELATED APPLICATIONS

This application claims priority under 35 U.S.C. § 119 to Korean Patent Application No's. 10-2021-0082336, filed on Jun. 24, 2021, and 10-2022-0034937, filed on Mar. 21, 2022, in the Korean Intellectual Property Office, the disclosures of which are incorporated by reference herein in their entireties.

### TECHNICAL FIELD

Embodiments of the inventive concept relate to a storage device, and more particularly, to a key-value storage device, a host communicating with the key-value storage device, and a host-storage system including the key-value storage device and the host.

### DISCUSSION OF RELATED ART

Storage devices may be classified into an object-based storage device and a block-based storage device according to units by which data is managed. An object-based storage device is a storage structure that stores and manages data in the form of objects. An object refers to data that may have any size, e.g., multimedia data such as a moving picture or an image and a file, and an object-based storage device may be used to manage objects. A key-value storage device is an example of an object-based storage device.

### SUMMARY

Embodiments of the inventive concept provide a host, a key-value storage device, and a host-storage system capable of reducing a software load of a file system for virtualizing a file or a directory and reducing an amount of input/output data between the host and a storage device.

According to an embodiment of the inventive concept, there is provided a host communicating with a key-value storage device, the host including an application and a file system configured to process a file or a directory related to file data received by the application to provide the file or the directory to the key-value storage device. The file system includes a mapping module configured to map the file or the directory to a key-value object storable in the key-value storage device, a translation module configured to translate a file operation requested by the application into a key-value operation that is performable in the key-value storage device, and a transaction management module configured to manage a transaction related to the key-value object and the key-value operation and provide the transaction to the key-value storage device. The mapping module abstracts the file or the directory into a meta-object or a data object.

According to an embodiment of the inventive concept, there is provided a key-value storage device including a non-volatile memory configured to store a plurality of key-value objects. The key-value objects include a meta-object including information of a file and a data object including content of the file, and a storage controller configured to receive key-value objects from a host and control the non-volatile memory based on received key-value objects. The storage controller includes an object indexing module configured to index the key-value objects, and a transaction supporting module configured to support a transaction for the key-value objects. The key-value storage device communicates with the host according to a key-value interface.

According to an embodiment of the inventive concept, there is provided a host-storage system including a key-value storage device, and a host configured to communicate with the key-value storage device according to a key-value interface. The host includes a file system configured to process a file or a directory related to file data received by the application to provide the file or the directory to the key-value storage device, and the file system maps the file or the directory to a key-value object storable in the key-value storage device, translates a file operation requested by the application into a key-value operation that is performable in the key-value storage device, and manages a transaction related to the key-value object and the key-value operation and provides the transaction to the key-value storage device.

According to an embodiment of the inventive concept, a host communicating with a key-value storage device includes a host memory that stores a computer program, and a host controller including a processor configured to execute the computer program. The computer program is configured to process a file or a directory related to file data received by an application stored in the host, and provide the file or the directory to the key-value storage device, map the file or the directory to a key-value object storable in the key-value storage device, translate a file operation requested by the application stored in the host into a key-value operation that is performable in the key-value storage device, manage a transaction related to the key-value object and the key-value operation and provide the transaction to the key-value storage device, and abstract the file or the directory into a meta-object or a data object.

According to an embodiment of the inventive concept, a key-value storage device includes a non-volatile memory configured to store a plurality of key-value objects, the key-value objects including a meta-object including information of a file and a data object including content of the file, and a storage controller including a memory that stores a computer program and a processor configured to execute the computer program, and configured to receive at least one of the key-value objects from a host and control the non-volatile memory based on the received at least one key-value object. The computer program is configured to index the received at least one key-value object, and support a transaction for the received at least one key-value object. The key-value storage device communicates with the host according to a key-value interface.

According to an embodiment of the inventive concept, a host-storage system includes a key-value storage device and a host configured to communicate with the key-value storage device according to a key-value interface. The host includes a host memory that stores a computer program, and a host controller including a processor configured to execute the computer program. The computer program is configured to process a file or a directory related to file data received by an application stored in the host, and provide the file or the directory to the key-value storage device, map the file or the directory to a key-value object storable in the key-value storage device, translate a file operation requested by the application into a key-value operation that is performable in the key-value storage device, and manage a transaction related to the key-value object and the key-value operation and provide the transaction to the key-value storage device.

### BRIEF DESCRIPTION OF THE DRAWINGS

The above and other features of the inventive concept will become more apparent by describing in detail embodiments thereof with reference to the accompanying drawings, in which:

FIG. 1 shows a host-storage system according to an embodiment of the inventive concept;

FIG. 2 is a block diagram illustrating a host of FIG. 1 according to an embodiment of the inventive concept;

FIG. 3 is a block diagram showing a host-storage system according to an embodiment of the inventive concept;

FIG. 4 shows an example of a key-value mapping operation of a file system according to an embodiment of the inventive concept;

FIG. 5 shows an example of a key-value operation translating operation of a file system according to an embodiment of the inventive concept;

FIG. 6 shows a file operation and a key-value operation of a file system according to an embodiment of the inventive concept;

FIG. 7 shows an example of a transaction management operation of a file system according to an embodiment of the inventive concept;

FIGS. 8 to 11 show examples of an operation of a file system according to embodiments of the inventive concept;

FIG. 12 is a block diagram showing a host-storage system according to an embodiment of the inventive concept;

FIG. 13 is a block diagram showing a storage controller according to an embodiment of the inventive concept;

FIG. 14 is a flowchart showing an operation between a host and a storage device according to an embodiment of the inventive concept; and

FIG. 15 shows a system to which a storage device according to an embodiment of the inventive concept is applied.

### DETAILED DESCRIPTION OF THE EMBODIMENTS

Embodiments of the inventive concept will be described more fully hereinafter with reference to the accompanying drawings. Like reference numerals may refer to like elements throughout the accompanying drawings.

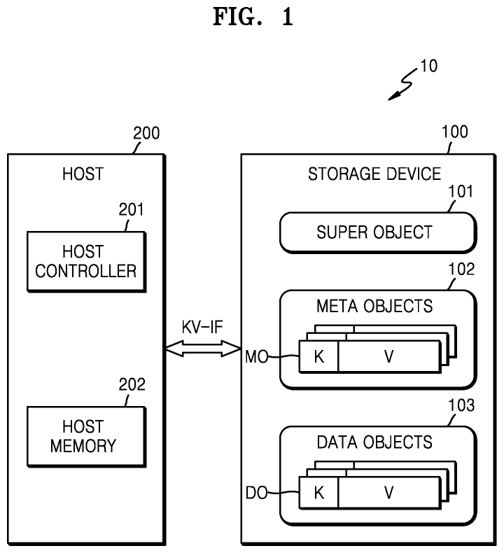

FIG. 1 shows a host-storage system 10 according to an embodiment of the inventive concept.

Referring to FIG. 1, the host-storage system 10 may include a storage device 100 and a host 200. In an embodiment, the storage device 100 may store and manage data in the form of objects each including a key K and a value V. Therefore, the storage device 100 may be referred to as a “key-value storage device”. In this specification, the storage device 100 may refer to a “key-value storage device”. For example, the storage device 100 may correspond to a key-value solid state drive (SSD).

The storage device 100 and the host 200 may communicate with each other through a key-value interface KV-IF. For example, according to the key-value interface KV-IF, the host 200 may provide a key-value command corresponding to a key-value operation, a command including a key, a key-value object, etc. to the storage device 100. Also, the storage device 100 may provide a key-value object or a response including a key to the host 200.

The storage device 100 may store a plurality of key-value objects, and the key-value objects may include a super object 101, meta-objects 102, and data objects 103. The super object 101 may store file system information. The meta-objects 102 may include a plurality of meta-objects MO that store metadata about a file (e.g., attributes of the file or a directory), and each meta-object MO may include a key K and a value V. The data objects 103 may include a plurality of data objects DO that store actual data for a file (e.g., file contents), and each data object DO may include a key K and a value V. Each key-value object may have a variable size.

A typical block storage device abstracts a storage medium as fixed-size logical blocks and provides block I/O operations. To virtualize files and directories on such a block storage device, the file system of a host maintains various on-disk data structures such as, for example, disk pointers, bitmaps, and directory entries. In this case, files and directories are a common way to abstract data.

Referring to a comparative example, a typical block storage device exports fixed-size logical blocks, and a host's file systems manage storage spaces (e.g., bitmaps) and data locations (e.g., inodes). Therefore, logical blocks are abstracted into directories and files containing user data. At this time, whenever files and directories are generated or deleted in the host, it is necessary to retrieve and update file system metadata (e.g., bitmaps and inodes) to reflect the newly updated state of a system. Therefore, in the case of a common block storage device according to a comparative example, software load on a file system is heavy, and the amount of input/output data between a host and the block storage device is large.

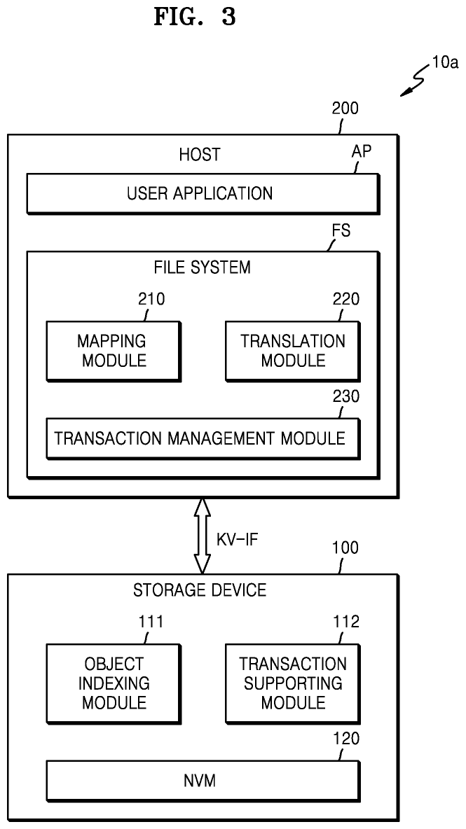

However, the storage device 100 according to an embodiment of the inventive concept may implement in-storage indexing of key-value objects in a physical address space of the storage device 100. For example, key-value objects exposed to a file system may be managed by an object indexing module (e.g., 111 of FIG. 3) in the storage device 100. The storage device 100 may map key-value objects to a physical address space and handle read and write requests for key-value objects. Therefore, whenever files and directories are generated or deleted in the host 200, it is not necessary to update file system metadata in the host 200, and file system metadata does not have to be exchanged between the host 200 and the storage device 100. Therefore, the software load on the file system of the host 200 may be significantly reduced, and the amount of input/output data between the host 200 and the storage device 100 may be significantly reduced.

The host 200 may include a host controller 201 and a host memory 202. The host memory 202 may function as a buffer memory for temporarily storing a key-value command or a key-value object to be transmitted to the storage device 100 or a key-value object transmitted from the storage device 100. For example, the host memory 202 may include an input/output queue. The host controller 201 may control an operation of storing a key-value object (e.g., write data) of a buffer region of the host memory 202 in the non-volatile memory 120 or an operation of storing a key-value object of the non-volatile memory 120 (e.g., read data) in the buffer region of the host memory 202.

According to an embodiment, the host controller 201 and the host memory 202 may be implemented as separate semiconductor chips. Alternatively, in some embodiments, the host controller 201 and the host memory 202 may be integrated on the same semiconductor chip. According to an embodiment, the host controller 201 may be any one of a plurality of modules included in an application processor, and the application processor may be implemented as a system-on-chip (SoC). For example, according to an embodiment, the host controller 201 may be implemented as a circuit including a processor, and may also be referred to herein as a host controller circuit or a host controller processor. Also, the host memory 202 may be an embedded memory provided in the application processor or a non-volatile memory or a memory module disposed outside the application processor.

As described above, according to an embodiment, the storage device 100 may be implemented as a key-value storage device equipped with an in-device indexing technology and a transaction function. Also, according to an embodiment, the host 200 may translate or convert a file or a directory and a file operation into the form of a key-value by utilizing the in-device indexing technology of the storage device 100 and ensure the consistency of the file system by using the transaction function of the storage device 100. Therefore, the amount of input/output data between the host 200 and the storage device 100 may be significantly reduced, thereby increasing the performance of the file system of the host 200. Also, metadata (e.g., bitmaps) not maintained by the storage device 100 is not fragmented, and object defragmentation may be performed through periodic operations (e.g., compaction, garbage collection, etc.) in the storage device 100. Therefore, performance degradation due to aging of the file system of the host 200 may be reduced.

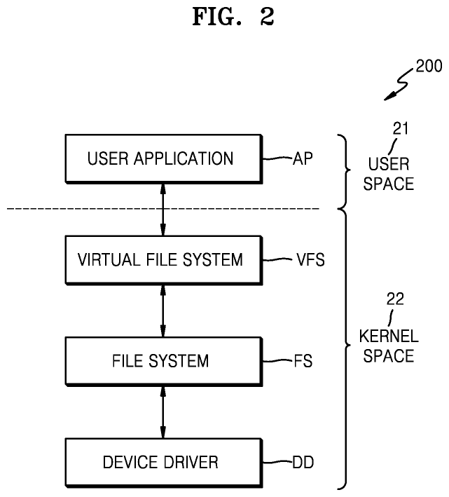

FIG. 2 is a block diagram illustrating the host 200 of FIG. 1 according to an embodiment of the inventive concept.

Referring to FIG. 2, the host 200 includes a user space 21 and a kernel space 22. Each component shown in FIG. 2 may refer to software or hardware such as, for example, a field-programmable gate array (FPGA), an application-specific integrated circuit (ASIC), a processor, etc. However, the components are not limited to software or hardware, and may also be configured to be in an addressable storage medium or configured to execute one or more processors. Functions provided in the components may be implemented by more subdivided components, or one component performing a particular function may be implemented by combining a plurality of components.

The user space 21 is a region in which a user application AP is executed, and the kernel space 22 is a restrictively reserved region for kernel execution. To access the kernel space 22 from the user space 21, a system call may be used.

The kernel space 22 may include a virtual file system VFS, at least one file system FS, and a device driver DD. The virtual file system VFS allows one or more file systems FS to interact with each other. The virtual file system VFS enables a standardized system call to be used to perform read/write operations on different file systems FS of different media. Therefore, for example, system calls like open( ) read( ) and write( ) may be used regardless of the type of the file system FS. In other words, the virtual file system VFS may be an abstraction layer existing between the user space 21 and the file system FS. The device driver DD is responsible for an interface between hardware and the user application AP (or operating system). The device driver DD is a program utilized for hardware to operate normally under a particular operating system.

FIG. 3 is a block diagram showing a host-storage system 10a according to an embodiment of the inventive concept.

Referring to FIG. 3, the host-storage system 10a may correspond to an implementation example of the host-storage system 10 of FIG. 1. The host 200 may include a user application or application AP and a file system FS. In an embodiment, in the host 200, the application AP and the file system FS may be implemented as software, and the application AP and the file system FS may be executed by the host controller (201 of FIG. 1). As described above, the host controller 201 may be implemented as circuit including a processor. According to an embodiment, the processor may be any of the types of processors described herein. According to an embodiment, the application AP and the file system FS may be stored in the host memory 202 of the host 200. The application AP and the file system FS may be collectively referred to as a computer program, which may be executed by the processor of the host controller 201 to perform operations according to the computer program (e.g., operations according to the application AP and the file system FS). For example, according to embodiments, program instructions stored in a computer program including the application AP and the file system FS may be executable by the processor of the host controller 201 to cause the processor to perform operations according to the program instructions. Accordingly, herein, it is to be understood that when an operation is described as being performed by a module, a unit, etc. of the host 200, the operation may be performed by the processor of the host controller 201 executing instructions of the module, unit, etc., to perform the corresponding operation. As shown in FIG. 2, the host 200 may further include a virtual file system VFS and a device driver DD. However, for convenience of illustration, only the application AP and the file system FS are shown in FIG. 3.

Although only one application AP is shown in FIG. 3, embodiments of the inventive concept are not limited thereto. According to embodiments, the host 200 may execute various applications, and the type of an application executed by the host 200 may be determined by a user input. For example, the application AP may include a multimedia playback application, an image recognition application, a voice recognition application, an encryption application, a search application, etc.

The file system FS is a data structure for storing files in the storage device 100. When user data or data is input through the application AP, the host 200 may process data through the file system FS and store processed data in the storage device 100. Hereinafter, data provided to the file system FS by the application AP will be referred to as “file data” or “host data.” Also, the host 200 may provide a transaction to the storage device 100, such that at least some of operations utilized to execute the application AP may be performed in the storage device 100. Hereinafter, an operation that may be performed by the host 200 to execute the application AP will be referred to as a “file operation” or a “host operation”.

The file system FS may receive file data from the application AP and process a file or a directory related to received file data to provide the file or the directory to the storage device 100. In an embodiment, the file system FS may include a mapping module 210, a translation module 220, and a transaction management module 230. The mapping module 210 may map file data to “key-value objects” that may be stored in the storage device 100. The translation module 220 may translate or convert a file operation into a “key-value operation” that may be performed by the storage device 100. The transaction management module 230 may manage or handle transactions that may be performed by the storage device 100. The transaction management module 230 may manage a transaction related to the key-value objects and the key-value operation. As such, the file system FS maps file data of the host 200 to key-value objects of the storage device 100 and translates or converts a file operation of the host 200 to a key-value operation of the storage device 100. Therefore, the file system FS may be referred to as a “key-value file system”.

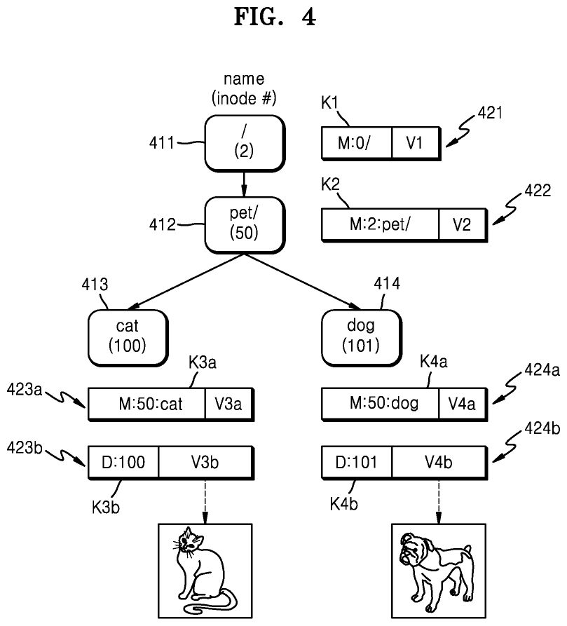

Referring to FIGS. 1 and 3 together, the mapping module 210 may map a file or a directory to a key-value object that may be stored in the storage device 100. For example, the mapping module 210 may abstract a file or directory into a meta-object MO or a data object DO. The mapping module 210 may map information of a file or a directory to a meta-object MO and map contents of a file to a data object DO. In an embodiment, the mapping module 210 may allocate a first key of the meta-object MO and a second key of the data object DO based on an inode of the file or the directory. For example, the mapping module 210 may generate a first key such that the first key of the meta-object MO includes a parent's inode number and a file name and generate a second key such that the second key of the data object DO includes the inode number of the file. Detailed operations of the mapping module 210 will be described in detail below with reference to FIG. 4.

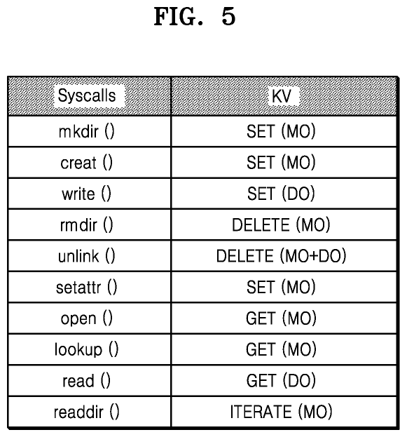

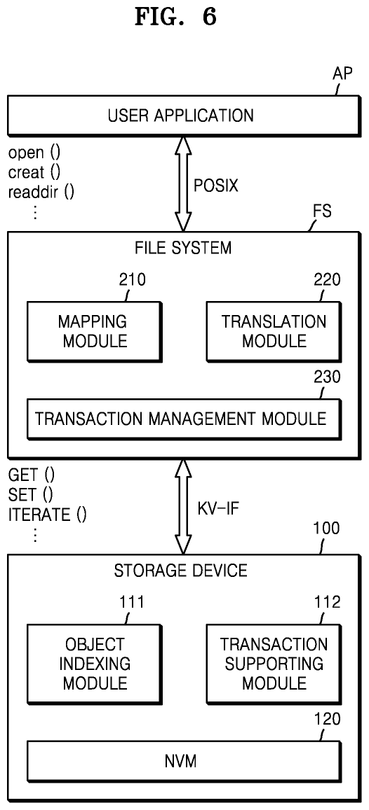

The translation module 220 may translate or convert a system call corresponding to a file operation into a key-value operation. The key-value operation may include a key-value command for a meta-object MO or a data object DO. In an embodiment, the translation module 220 may translate one system call corresponding to a file operation into a plurality of key-value operations. In an embodiment, before performing a key-value operation in the storage device 100, the translation module 220 may process the corresponding key-value operation in a cache memory in the file system FS. Detailed operations of the translation module 220 will be described in detail below with reference to FIGS. 5 and 6.

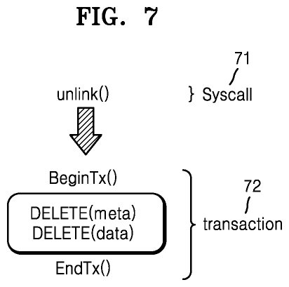

The transaction management module 230 may manage a plurality of key-value operations corresponding to one system call as one transaction, thereby ensuring atomicity for a plurality of key-value objects. According to embodiments, the transaction management module 230 may be referred to as a transaction handler. The transaction management module 230 may maintain the consistency of the file system FS with a low load by utilizing a transaction function provided by the storage device 100. The transaction management module 230 may track all file operations and perform input/output to the storage device 100 in consideration of an order and correlation between the file operations. Detailed operations of the transaction management module 230 will be described in detail below with reference to FIG. 7.

The storage device 100 may include an object indexing module 111, a transaction supporting module 112, and a non-volatile memory 120. In an embodiment, the object indexing module 111 and the transaction supporting module 112 may be implemented in software and may be loaded into a working memory. In an embodiment, the object indexing module 111 and the transaction supporting module 112 may be implemented in a host interface layer. According to embodiments, the object indexing module 111 may be referred to as an in-storage indexing engine.

The object indexing module 111 may index key-value objects. Therefore, in the storage device 100, since data input/output for indexing key-value objects occurs within the storage device 100, the amount of input/output data between the host 200 and the storage device 100 may be reduced. Also, since the storage device 100 performs key-value object indexing, the file system FS of the host 200 does not need to manage inodes, bitmaps, disk pointers, and directory entries for files, and thus, the software load may be reduced. As described above, according to an embodiment, by offloading an object indexing function to the storage device 100, the file system FS of the host 200 may be implemented as a lightweight file system.

Referring to FIGS. 1 and 3 together, the object indexing module 111 may index a meta-object MO and a data object DO. The key of the meta-object MO may correspond to a file name or a directory name in a general file system, and the value of the meta-object MO may correspond to an inode. According to a comparative example, a file system performs read and write operations on blocks to modify a list of directory entries. However, in contrast, according to embodiments of the inventive concept, the object indexing module 111 may update directory entries by writing a meta-object MO (e.g., SET(MO)) or removing a meta-object MO (e.g., DELETE(MO)). Therefore, the amount of input/output data between the host 200 and the storage device 100 may be reduced.

When a large object having a large data object is indexed in the form of a single key-value pair, a large input/output overhead is caused even when a part of the large object is read or updated. However, according to embodiments of the inventive concept, the object indexing module 111 may split a data object DO into sub-objects having unique suffixes, and manage the sub-objects as independent key-value pairs. When the size of a data object DO (e.g., “/home/alice/bob.txt”) is 32 KB, the object indexing module 111 may split the data object DO into eight 4 KB sub-objects with different suffixes. e.g., d:100:0, d:100:1, d:100:2, d:100:3, d:100:4, d:100:5, d:100:6, and d:100:7. Therefore, when only a part of a large object is retrieved or updated, only a read operation or a write operation for a corresponding sub-object may be performed, and thus, the input/output overhead may be reduced.

The transaction supporting module 112 may support a transaction for a key-value object. For example, the transaction supporting module 112 may provide a transaction application programming interface (API), thereby providing atomicity and durability for a plurality of key-value objects. As described above, the storage device 100 may perform various arithmetic operations on key-value objects, and thus, the storage device 100 may be referred to as an arithmetic storage device or an arithmetic key-value storage device.

For example, the transaction supporting module 112 may use three data structures, that is, a transaction table TxTable, transaction logs TxLogs, and a recovery log TxRecovery. The transaction table TxTable may store transaction information. The transaction logs TxLogs store key-value indexes of key-value objects related to a transaction and may be stored in the non-volatile memory 120 or a DRAM. The recovery log TxRecovery may be used to recover or abort transactions during recovery.

The non-volatile memory 120 may store a plurality of key-value objects, and the key-value objects may include meta-objects including information regarding a file and a data object including contents of the file. According to some embodiments, the NVM 120 may be implemented with a plurality of memory chips or a plurality of memory dies. For example, the memory chips may each be a dual die package (DDP), a quadruple die package (QDP), or an octuple die package (ODP).

When the non-volatile memory 120 includes a flash memory, the flash memory may include a 2D NAND memory array or a 3D (or vertical) NAND (VNAND) memory array. In another example, the storage device 100 may include various other types of non-volatile memories. For example, the storage device 100 may include a magnetic RAM (MRAM), a spin-transfer torque MRAM, a conductive bridging RAM (CBRAM), a ferroelectric RAM (FeRAM), a phase RAM (PRAM), a resistive RAM, and various other types of memories.

FIG. 4 shows an example of a key-value mapping operation of a file system according to an embodiment of the inventive concept.

Referring to FIGS. 3 and 4 together, the mapping module 210 may map information of a file or a directory to a meta-object and may map the content of the file to a data object. In an embodiment, the mapping module 210 may allocate a first key of a meta-object and a second key of a data object by allocating keys based on the Mode number of a file or a directory. In this case, only general files are mapped to meta-objects and data objects, and directories may be mapped only to meta-objects. Therefore, according to an embodiment, the load on directory entries existing in an existing file system may be removed.

For example, the mapping module 210 may generate a first key of a meta-object, such that the first key includes a parent's Mode number and a file name. For example, the mapping module 210 may allocate a key of a meta-object as “M: parent's mode number: file name”. In this regard, by setting the key of a meta-object, all child files in the same parent directory may be stored adjacent to one another, thereby ensuring high read performance. Also, the mapping module 210 may generate a second key of a data object, such that the second key includes the inode number of a file. For example, the mapping module 210 may allocate the key of a data object as “D: corresponding file's inode number”.

For example, the mapping module 210 may map a root directory 411 to a meta-object 421, and the meta-object 421 may include a key K1 assigned as “M:0/” and a value V1. For example, when the inode number of the root directory 411 is 2, the mapping module 210 may map a sub-directory 412 to a meta-object 422, and the meta-object 422 may include a key K2 and a value V2. Here, the key K2 may be assigned as “M:2:pet/” including the inode number 2 of the root directory 411 and a file name ‘pet’.

For example, when the inode number of the sub-directory 412 is 50 and the inode number of a first file 413 is 100, the mapping module 210 may map the first file 413 to a meta-object 423a and a data object 423b, the meta-object 423a may include a key K3a and a value V3a, and the data object 423b may include a key K3b and a value V3b. In this case, the key K3a of the meta-object 423a may be assigned as “M:50:cat” including the inode number 50 of the sub-directory 412 and a file name ‘cat’, and the key K3b of the data object 423b may be assigned as “D:100” including the inode number 100 of the first file 413. The value V3a of the meta-object 423a may include file information of the first file 413, a generation time of meta-data, etc., and the value V3b of the data object 423b may correspond to actual content, e.g., a picture or a video of a cat, etc.

For example, when the inode number of the sub-directory 412 is 50 and the inode number of a second file 414 is 101, the mapping module 210 may map the second file 414 to a meta-object 424a and a data object 424b, the meta-object 424a may include a key K4a and a value V4a, and the data object 424b may include a key K4b and a value V4b. In this case, the key K4a of the meta-object 424a may be assigned as “M:50:dog” including the inode number 50 of the sub-directory 412 and a file name ‘dog’, and the key K4b of the data object 424b may be assigned as “D:101” including the mode number 101 of the second file 414. The value V4a of the meta-object 424a may include file information of the second file 414, a generation time of meta-data, etc., and the value V4b of the data object 424b may correspond to actual content, e.g., a picture or a video of a dog, etc.

By configuring a key according to the above-described embodiment, high ITERATE performance may be ensured when using the storage device 100 that sorts and stores key-values. Also, high rename operation load that may occur when keys are configured using the absolute path to a file may be removed.

FIG. 5 shows an example of a key-value operation translating operation of a file system according to an embodiment of the inventive concept.

Referring to FIGS. 3 and 5 together, the translation module 220 may translate a file operation corresponding to a system call into a key-value operation. In an embodiment, a file operation may correspond to a portable operating system interface (POSIX) system call. A key-value operation may include a key-value operation on a meta-object MO and a key-value operation on a data object DO.

For example, the translation module 220 may translate mkdir( ) to SET(MO), translate creat( ) to SET(MO), translate write( ) to SET(DO), translate rmdir( ) to DELETE(MO), translate unlink( ) to DELETE(MO+DO), translate setattr( ) to SET(MO), translate open( ) to GET(MO), translate lookup( ) to GET(MO), translate read( ) to GET(DO), and translate readdir( ) to ITERATE(MO).

In the case of a general block storage device, to perform a write operation, input/output of file system metadata like bitmaps, Modes, directory entries, and disk pointers are performed between a host and the storage device. However, in the case of the storage device 100 according to an embodiment, since the host 200 and the storage device 100 communicate with each other according to the key-value interface KV-IF, the input/output of file system metadata is not performed. Therefore, the amount of input/output data between the host 200 and the storage device 100 may be significantly reduced. Also, the file system FS may provide intuitive and simple operation translation, and input/output operations may be significantly reduced as compared to an existing file system.

FIG. 6 shows a file operation and a key-value operation of the file system FS according to an embodiment of the inventive concept.

Referring to FIGS. 3 and 6 together, the application AP and the file system FS may communicate with each other, for example, according to the POSIX. The application AP may request a POSIX operation like open( ) creat( ) and readdir( ) that is a file operation, to the file system FS. The translation module 220 of the file system FS may translate a POSIX operation into a key-value operation, e.g., GET( ) SET( ) ITERATE( ) etc.

The file system FS may provide key-value commands respectively according to various key-value operations to the storage device 100 through the key-value interface KV-IF. Therefore, the storage device 100 may perform various operations such as, for example, object indexing, transaction, object storage or object reading according to key-value operations respectively corresponding to received key-value commands.

FIG. 7 shows an example of a transaction management operation of a file system according to an embodiment of the inventive concept.

Referring to FIGS. 3 and 7 together, the translation module 220 may translate one system call 71, e.g., unlink( ) to a plurality of key-value operations, e.g., two key-value operations DELETE(meta) and DELETE(data). The transaction management module 230 may manage a plurality of key-value operations corresponding to the one system call 71, e.g., the two key-value operations DELETE(meta) and DELETE(data), as one transaction 72.

Therefore, the host 200 may provide the transaction 72 to the storage device 100 through the key-value interface KV-IF, and the transaction supporting module 112 of the storage device 100 may perform the transaction 72. For example, the host 200 may provide BeginTx( ) instructing the start of a new transaction to the storage device 100, provide key-value commands corresponding to DELETE(meta) and DELETE(data) to the storage device 100, and provide EndTx( ) instructing the end of the transaction to the storage device 100. In this regard, the transaction supporting module 112 may guarantee the atomicity of operations included in the one transaction 72 by providing transaction-related functions of BeginTx( ) and EndTx( ).

In an embodiment, when BeginTx( ) is received, the storage device 100 may create a new entry in the transaction table TxTable. When a subsequent command belonging to a transaction arrives, the storage device 100 may maintain key-value indexes in the transaction logs TxLogs existing in a memory and may buffer related values. When EndTx(TID) is received, the storage device 100 may commit a related transaction and change the state of the transaction to COMMITTED. Also, the storage device 100 may notify the host 200 that the transaction is committed.

When the file system FS performs input/output operations, a transaction function may be utilized for each file operation. In this regard, inputs and outputs generated by one file operation are treated as one transaction, and thus, the atomicity of the file operation may be guaranteed. However, since the load of the storage device 100 may increase when all file operations are processed as respective transactions, the file system FS may process multiple transactions once per period when there is no explicit synchronization function, e.g., fsync( ). On the other hand, when an explicit synchronization function like fsync( ) is invoked, the file system FS may select only operations related to a corresponding file from among buffered file operations and perform transaction processing together with the corresponding operation. In this case, to maintain correlation between file operations, the file system FS may maintain the corresponding correlation within the file system FS.

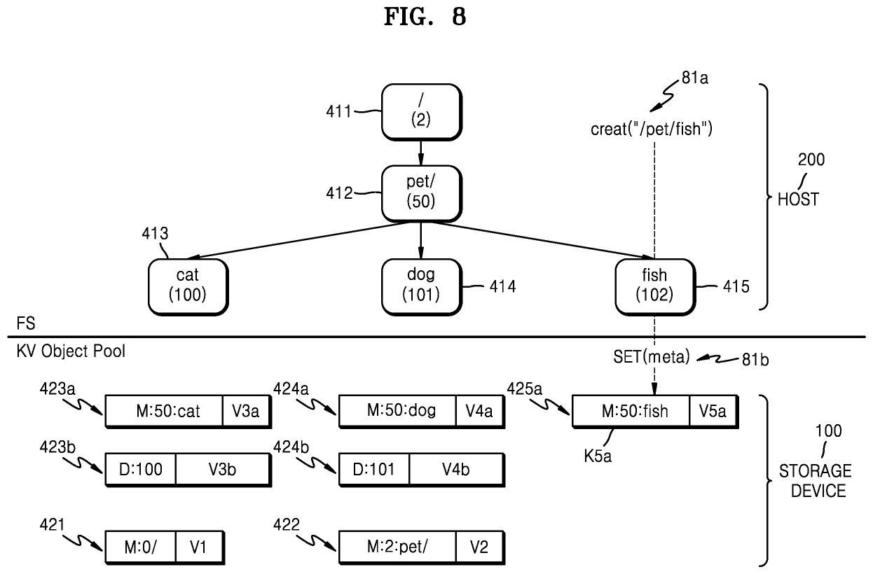

FIG. 8 shows an example of an operation of the file system FS according to an embodiment of the inventive concept.

Referring to FIGS. 3 and 8 together, to store a newly generated third file 415 in the storage device 100, the file system FS may map file information corresponding to the third file 415 to a meta-object 415a and translate a file operation related to the third file 415 into a key-value operation. For example, the translation module 220 of the file system FS may translate a system call 81a for storing the file information of the third file 415 in the storage device 100, e.g., creat(“/pet/fish”) into a key-value operation 81b, e.g., SET(meta).

Also, the mapping module 210 of the file system FS may map information regarding the third file 415 to a meta-object 425a including a key K5a and a value V5a. In this case, the key K5a of the meta-object 425a may be allocated as “M:50:fish” to include the parent's inode number 50 and a file name ‘fish’, and the value V5a of the meta-object 425a may include file information of the third file 415, a generation time of meta-data, etc.

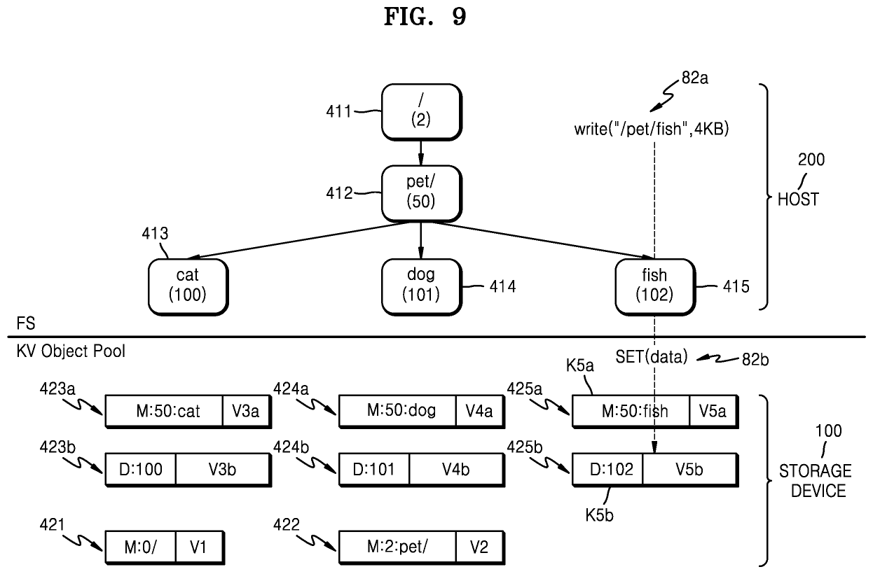

FIG. 9 shows an example of an operation of the file system FS according to an embodiment of the inventive concept.

Referring to FIGS. 3 and 9 together, to store a newly generated third file 415 in the storage device 100, the file system FS may map contents of the third file 415 to a data object 415b and translate a file operation related to the third file 415 into a key-value operation. For example, the translation module 220 of the file system FS may translate a system call 82a for storing the contents of the third file 415 in the storage device 100, e.g., write(“/pet/fish”, 4 KB) into a key-value operation 82b, e.g., SET(data).

Also, the mapping module 210 of the file system FS may map the contents of the third file 415 to a data object 425b including a key K5b and a value V5b. In this case, the key K5b of the data object 425b may be assigned as “D:102” to include 102, which is the inode number of the third file 415. For example, the value V5b of the data object 425b may correspond to data such as, for example, a picture or a video corresponding to a fish.

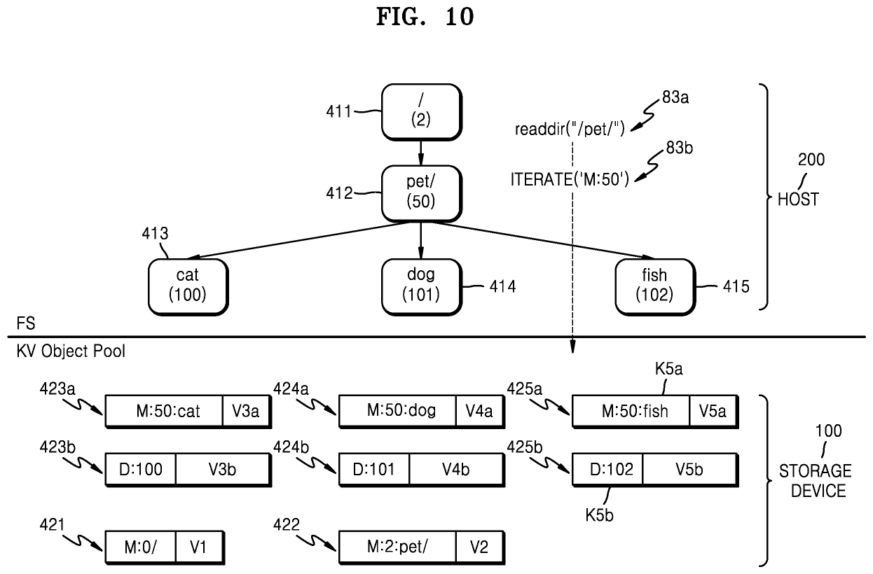

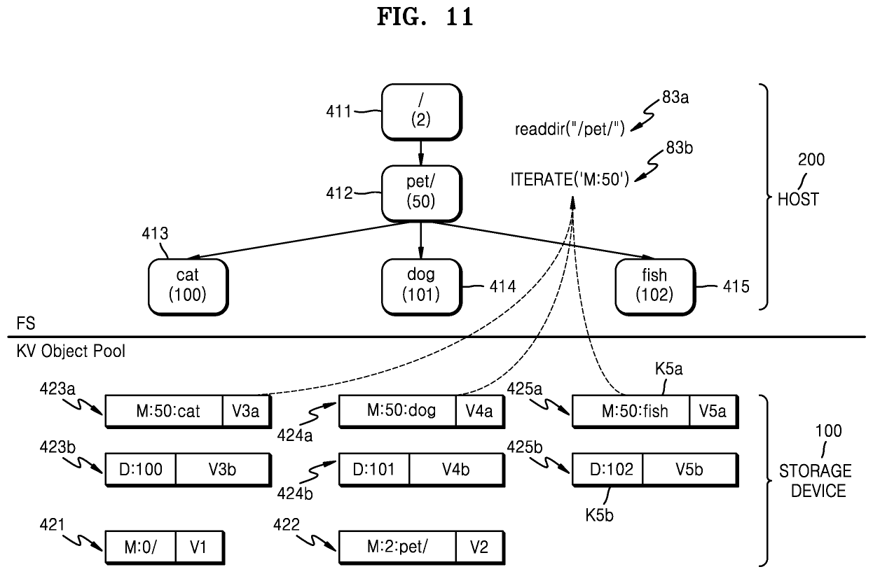

FIGS. 10 and 11 show examples of an operation of the file system FS according to an embodiment of the inventive concept.

Referring to FIGS. 3, 10, and 11 together, to retrieve objects corresponding to first to third files 413, 414, and 415 related to ‘pet’ from the storage device 100, the file system FS may translate a file operation related to the retrieval of the first to third files 413, 414, and 415 into a key-value operation. For example, the translation module 220 of the file system FS may translate a system call 83a (e.g., readdir(“/pet/”)) for reading the sub-contents of the sub-directory 412 from the storage device 100 into a key-value operation 83b (e.g., ITERATE(‘M:50’)). The file system FS may provide a key-value command corresponding to the key-value operation 83b, that is, ITERATE(‘M:50’), to the storage device 100. Subsequently, the storage device 100 may return (e.g., provide) a plurality of meta-objects 423a, 424a, and 425a including ‘M:50’ in the keys thereof to the host 200.

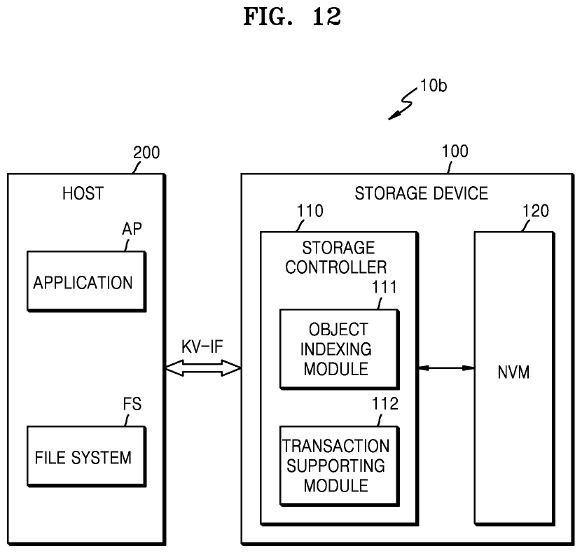

FIG. 12 shows a host-storage system 10b according to an embodiment of the inventive concept.

Referring to FIG. 12, the host-storage system 10b may correspond to an implementation example of the host-storage system 10 of FIG. 1, and the descriptions given above with reference to FIGS. 1 to 11 may also be applied to an embodiment according to FIG. 12. The storage device 100 may include a storage controller 110 and the non-volatile memory 120. According to some embodiments, the storage controller 110 may be referred to as a controller, a device controller, or a memory controller. Hereinafter, descriptions will be given with reference to FIGS. 1 and 12 together.

The storage controller 110 may control the non-volatile memory 120 to write a data object DO to the non-volatile memory 120 in response to a write command (e.g., SET(DO)) from the host 200. Also, the storage controller 110 may control the non-volatile memory 120 to read a data object DO stored in the non-volatile memory 120 in response to a read command (e.g., GET(DO)) from the host 200. In this regard, the storage device 100 may perform data writing operation and data reading operation similar to those of a general storage device.

Also, according to an embodiment, the storage controller 110 may include the object indexing module 111 and the transaction supporting module 112. For example, the object indexing module 111 and the transaction supporting module 112 may be implemented in software and may be stored in the non-volatile memory 120. When power is applied to the storage device 100, the object indexing module 111 and the transaction supporting module 112 may be loaded into a working memory of the storage controller 110 from the non-volatile memory 120.

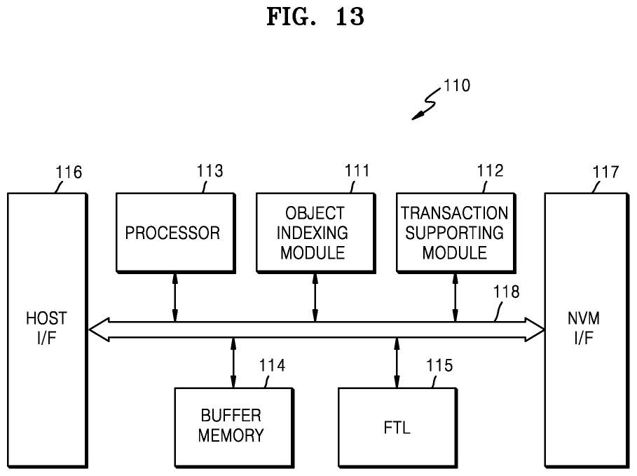

FIG. 13 is a block diagram showing a storage controller 110 according to an embodiment of the inventive concept.

Referring to FIG. 13, the storage controller 110 may include the object indexing module 111, the transaction supporting module 112, a processor 113, a buffer memory 114, a flash translation layer (FTL) 115, a host interface 116, and a non-volatile memory interface 117, which may communicate with one another over a bus 118. Hereinafter, descriptions will be given with reference to FIGS. 12 and 13 together.

The processor 113 may include a central processing unit (CPU) or a microprocessor and may control the overall operation of the storage controller 110. In an embodiment, the processor 113 may be implemented as a multi-core processor, e.g., a dual-core processor or a quad-core processor. The object indexing module 111, the transaction supporting module 112, and the FTL 115 may be loaded into a working memory of the storage controller 110. For example, the working memory may be implemented as a volatile memory such as, for example, an SRAM or a DRAM, or a non-volatile memory such as, for example, a flash memory or a PRAM.

As the processor 113 executes the FTL 115 loaded into the working memory, write and read operations for a meta-object or a data object for the non-volatile memory 120 may be controlled. The FTL 115 may perform various functions such as, for example, wear-leveling and garbage collection. Wear-leveling is a technique for preventing or reducing excessive degradation of a particular block by allowing memory blocks in the NVM 120 to be uniformly used and may be, for example, implemented through a firmware technology for balancing erase counts of physical blocks. Garbage collection is a technique for securing usable capacity in the NVM 120 by copying effective data of a memory block to a new block and then erasing the previous block.

The buffer memory 114 may temporarily store a meta-object and a data object to be written to the non-volatile memory 120 or a meta-object and a data object read from the non-volatile memory 120. The buffer memory 114 may be a component provided in the storage controller 110, but may also be provided outside the storage controller 110.

The host interface 116 may transmit/receive a key-value command and a key-value object to/from the host 200. A key-value object transmitted from the host 200 to the host interface 116 may include data to be programmed to the non-volatile memory 120, and a key-value object transmitted from the host interface 116 to the host 200 may include a response to a key-value command or data read from the non-volatile memory 120.

The non-volatile memory interface 117 may transmit data to be written to the non-volatile memory 120 to the non-volatile memory 120 or receive data read from the non-volatile memory 120. The non-volatile memory interface 117 may be implemented to comply with a standard protocol such as, for example, the Toggle or the Open NAND Flash Interface (ONFI).

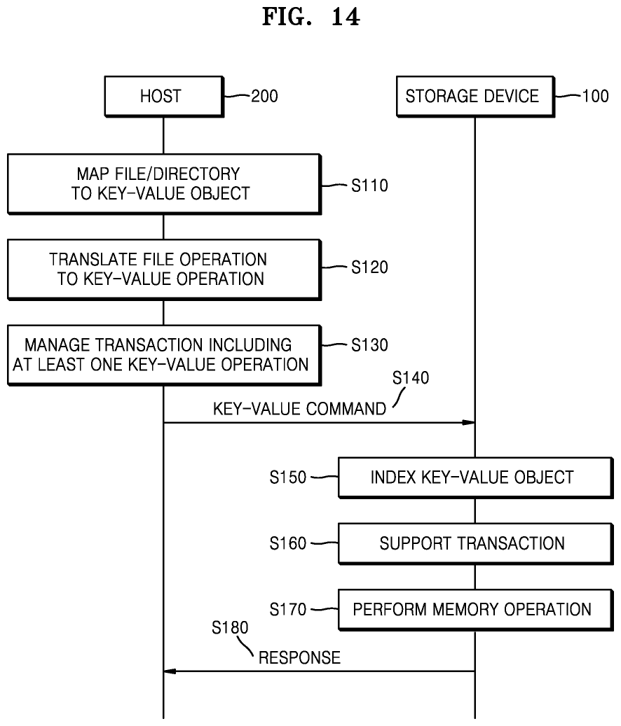

FIG. 14 is a flowchart showing an operation between the host 200 and the storage device 100 according to an embodiment of the inventive concept. The descriptions given above with reference to FIGS. 1 to 13 may also be applied to an embodiment according to FIG. 14, and thus, for convenience of explanation, a further description of components and technical aspects previously described will be omitted.

Referring to FIG. 14, in operation S110, the host 200 maps a file or directory to a key-value object. In operation S120, the host 200 translates a file operation into a key-value operation. According to embodiments, operation S120 may be performed before operation S110, or operations S110 and S120 may be performed substantially simultaneously. In operation S130, the host 200 manages a transaction including at least one key-value operation. In operation S140, the host 200 transmits a key-value command to the storage device 100.

In operation S150, the storage device 100 indexes key-value objects. In operation S160, the storage device 100 supports the transaction. In operation S170, the storage device 100 performs a memory operation including a read operation and a write operation on a non-volatile memory according to the transaction. In operation S180, the storage device 100 provides a response to the host 200. For example, the response may include a key or both a key and a value.

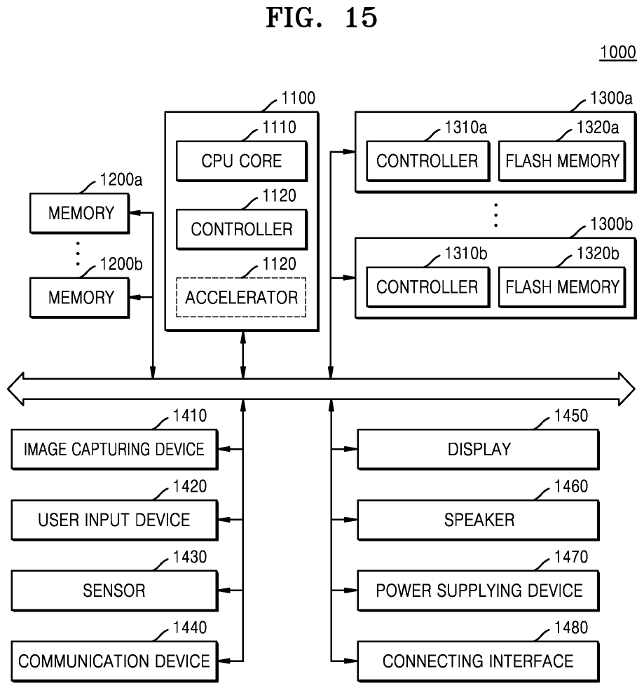

FIG. 15 shows a system 1000 to which a storage device according to an embodiment of the inventive concept is applied. The system 1000 of FIG. 15 may be, for example, a mobile system such as a mobile phone, a smartphone, a tablet personal computer (PC), a wearable device, a healthcare device, or an Internet of Things (IoT) device. However, the system 1000 of FIG. 15 is not necessarily limited to a mobile system, and may include, for example, a personal computer, a laptop computer, a server, a media player, or an automobile device such as, for example, a navigation device.

Referring to FIG. 15, the system 1000 may include a main processor 1100, memories 1200a and 1200b, and storage devices 1300a and 1300b, and may additionally include at least one of an image capturing device 1410, a user input device 1420, a sensor 1430, a communication device 1440, a display 1450, a speaker 1460, a power supplying device 1470, and a connecting interface 1480.

The main processor 1100 may control the overall operation of the system 1000, and more particularly, the operations of other components constituting the system 1000. The main processor 1100 may be implemented with, for example, a general-purpose processor, a dedicated processor, or an application processor. In an embodiment, the main processor 1100 may correspond to the host 200 described above with reference to FIGS. 1 to 14. Accordingly, the main processor 1100 may include a lightweight file system, which may map file data to key-value objects, translate file operations into key-value operations, and manage a transaction based on key-value objects and keys-value operations.

The main processor 1100 may include one or more CPU cores 1110 and may further include a controller 1120 for controlling the memories 1200a and 1200b and/or the storage devices 1300a and 1300b. According to embodiments, the main processor 1100 may further include an accelerator 1130, which is a dedicated circuit for high-speed data operation such as artificial intelligence (AI) data operation. The accelerator 1130 may include, for example, a graphics processing unit (GPU), a neural processing unit (NPU), and/or a data processing unit (DPU), and may also be implemented as a separate chip physically independent from the other components of the main processor 1100.

The memories 1200a and 1200b may be used as the main memory device of the system 1000 and may include volatile memories such as, for example, SRAMs and/or DRAMs. However, embodiments of the inventive concept are not limited thereto, and the memories 1200a and 1200b may also include non-volatile memories such as, for example, flash memories, PRAMs, and/or RRAMs. The memories 1200a and 1200b may be implemented in the same package as the main processor 1100.

The storage devices 1300a and 1300b may function as non-volatile storage devices that store data regardless of whether power is supplied, and may have a relatively large storage capacity as compared to the memories 1200a and 1200b. The storage devices 1300a and 1300b may include storage controllers 1310a and 1310b and non-volatile memories (NVMs) 1320a and 1320b that stores data under the control of the storage controllers 1310a and 1310b. The NVMs 1320a and 1320b may include a flash memory having a 2-dimensional (2D) structure or a 3-dimensional (3D) V-NAND (vertical NAND) structure, but may also include other types of non-volatile memories such as, for example, a PRAM and/or an RRAM.

The storage devices 1300a and 1300b may be included in the system 1000 while being physically separated from the main processor 1100, or may be implemented in the same package as the main processor 1100. Also, the storage devices 1300a and 1300b may be in the form of solid state devices (SSD) or memory cards, and thus, the storage devices 1300a and 1300b may be detachably attached to the other components of the system 1000 through an interface such as, for example, a connecting interface 1480 to be described later. The storage devices 1300a and 1300b may be devices to which standard protocols such as, for example, universal flash storage (UFS), embedded multi-media card (eMMC), or non-volatile memory express (NVMe) are applied, but are not necessarily limited thereto.

In an embodiment, the storage devices 1300a and 1300b may correspond to the storage device 100 described above with reference to FIGS. 1 to 14. Therefore, the storage devices 1300a and 1300b may support an in-device indexing technology for indexing key-value objects and a transaction function for key-value objects. For example, storage controllers 1310a and 1310b may each include the object indexing module 111 and the transaction supporting module 112. Also, the non-volatile memories 1320a and 1320b may store a plurality of key-value objects, and the key-value objects may include a meta-object including information of a file and a data object including the contents of the file.

The image capturing device 1410 may capture a still image or a moving picture, and may include, for example, a camera, a camcorder, and/or a webcam. The user input device 1420 may receive various types of data input from a user of the system 1000 and may include, for example, a touch pad, a keypad, a keyboard, a mouse, and/or a microphone.

The sensor 1430 may sense various types of physical quantities that may be obtained from outside the system 1000 and transform sensed physical quantities into electrical signals. The sensor 1430 may include, for example, a temperature sensor, a pressure sensor, an illuminance sensor, a positional sensor, an acceleration sensor, a biosensor, and/or a gyroscope sensor.

The communication device 1440 may transmit and receive signals to and from other devices outside the system 1000 according to various communication protocols. The communication device 1440 may include, for example, an antenna, a transceiver, and/or a modem. The display 1450 and the speaker 1460 may function as output devices that output visual and auditory information to a user of the system 1000, respectively. The power supplying device 1470 may appropriately convert power supplied from a battery embedded to the system 1000 and/or power supplied from an external power source and supply converted power to the components of the system 1000.

The connecting interface 1480 may provide a connection between the system 1000 and an external device, which is connected to the system 1000 and is capable of exchanging data with the system 1000. The connecting interface 1480 may be implemented according to various interface protocols such as, for example, an advanced technology attachment (ATA), a serial ATA (SATA), an external SATA (e-SATA), a small computer small interface (SCSI), a serial attached SCSI (SAS), a peripheral component interconnection (PCI), PCI express (PCIe), an NVM express (NVMe), an IEEE 1394, a universal serial bus (USB), a secure digital (SD) card, a multi-media card (MMC), an embedded multi-media card (eMMC), a universal flash storage (UFS), embedded universal flash storage (eUFS), a compact flash (CF) card interface, etc.

As is traditional in the field of the inventive concept, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the invention. Further, the blocks, units and/or modules of the embodiments may be physically combined into more complex blocks, units and/or modules without departing from the scope of the inventive concept.

As will be appreciated by one skilled in the art, aspects of the present inventive concept may be embodied as a system, method or computer program product. Accordingly, aspects of the present inventive concept may take the form of an entirely hardware embodiment, an entirely software embodiment (including firmware, resident software, micro-code, etc.) or an embodiment combining software and hardware aspects that may all generally be referred to herein as a “circuit,” “module,” “unit” or “system.” Furthermore, aspects of the present inventive concept may take the form of a computer program product embodied in one or more computer readable medium(s) having computer readable program code embodied thereon. If implemented in software, the functions may be stored on or transmitted over as one or more instructions or code on a tangible, non-transitory computer-readable medium.

Herein, the term “circuit” may refer to an analog circuit or a digital circuit. In the case of a digital circuit, the digital circuit may be hard-wired to perform the corresponding tasks of the circuit, such as a digital processor that executes instructions to perform the corresponding tasks of the circuit. Examples of such a processor include an application-specific integrated circuit (ASIC) and a field-programmable gate array (FPGA).

In an embodiment of the inventive concept, a three-dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array. In an embodiment of the inventive concept, the 3D memory array includes vertical NAND strings that are vertically oriented such that at least one memory cell is located over another memory cell. The at least one memory cell may include a charge trap layer. The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

While the inventive concept has been particularly shown and described with reference to embodiments thereof, it will be understood that various changes in form and detail may be made therein without departing from the spirit and scope of the inventive concept as defined by the following claims.

What is claimed is:

1. A host communicating with a key-value storage device, the host comprising:
a host memory that stores a computer program; and
a host controller including a processor configured to execute the computer program, wherein the computer program is configured to:
process a file or a directory related to file data received by an application stored in the host, and provide the file or the directory to the key-value storage device;
map the file or the directory to a key-value object storable in the key-value storage device;
translate a file operation requested by the application stored in the host into a key-value operation that is performable in the key-value storage device;
manage a transaction related to the key-value object and the key-value operation and provide the transaction to the key-value storage device; and
abstract the file or the directory into a meta-object or a data object.

2. The host of claim 1, wherein the computer program is further configured to:
map information of the file or the directory to the meta-object; and
map contents of the file to the data object.

3. The host of claim 1, wherein the computer program is further configured to:
allocate a first key of the meta-object and a second key of the data object based on an inode of the file or the directory.

4. The host of claim 3, wherein the computer program is further configured to:
generate the first key, wherein the first key includes an inode number of a parent and a file name; and
generate the second key, wherein the second key includes the inode number of the file.

5. The host of claim 1, wherein the computer program is further configured to:
translate a system call corresponding to the file operation into the key-value operation,
wherein the key-value operation includes a key-value command for the meta-object or the data object.

6. The host of claim 5, wherein the computer program is further configured to:
translate the system call corresponding to the file operation into a plurality of key-value operations,
wherein the key-value operation is one of the plurality of key-value operations.

7. The host of claim 6, wherein the computer program is further configured to:
manage the key-value operations corresponding to the system call as one transaction.

8. The host of claim 1,
wherein the computer program stored in the host memory includes the application and a file system, and the application and the file system are executed by the processor of the host controller.

9. The host of claim 1,
wherein the host communicates with the key-value storage device according to a key-value interface.

10. A key-value storage device, comprising:
a non-volatile memory configured to store a plurality of key-value objects, wherein the key-value objects include a meta-object including information of a file and a data object including content of the file; and
a storage controller including a memory that stores a computer program and a processor configured to execute the computer program, and configured to receive at least one of the key-value objects from a host and control the non-volatile memory based on the received at least one key-value object,
wherein the computer program is configured to:
index the received at least one key-value object; and
support a transaction for the received at least one key-value object,
wherein the key-value storage device communicates with the host according to a key-value interface.

11. The key-value storage device of claim 10, wherein the computer program is further configured to:
receive a key-value command from the host and perform a key-value operation corresponding to the key-value command on the received at least one key-value object.

12. The key-value storage device of claim 10,
wherein the transaction includes a plurality of key-value operations corresponding to one system call,
the key-value operation is one of the plurality of key-value operations, and
the computer program is further configured to support the key-value operations according to the transaction.

13. The key-value storage device of claim 10,
wherein the received at least one key-value object includes the meta-object and the data object, and
the computer program is further configured to obtain information of the file based on the meta-object and allocate a physical storage space for a value of the data object based on a key of the data object.

14. The key-value storage device of claim 10, wherein the computer program is further configured to:
perform the transaction on the received at least one key-value object and store a result of the transaction in the non-volatile memory.

15. The key-value storage device of claim 10, wherein the computer program is further configured to:
read the data object from the non-volatile memory and perform the transaction on the data object.

16. The key-value storage device of claim 10,
wherein a key of the meta-object includes an inode number of a parent and a file name, and
a key of the data object includes an inode number of the file.

17. A host-storage system, comprising:
a key-value storage device; and
a host configured to communicate with the key-value storage device according to a key-value interface,
wherein the host comprises:
a host memory that stores a computer program; and
a host controller including a processor configured to execute the computer program, wherein the computer program is configured to:
process a file or a directory related to file data received by an application stored in the host, and provide the file or the directory to the key-value storage device;
map the file or the directory to a key-value object storable in the key-value storage device;
translate a file operation requested by the application into a key-value operation that is performable in the key-value storage device; and
manage a transaction related to the key-value object and the key-value operation and provide the transaction to the key-value storage device.

18. The host-storage system of claim 17, wherein the key-value storage device comprises:
a non-volatile memory configured to store a plurality of key-value objects including the key value object, wherein the key-value objects include a meta-object including information of a file and a data object including content of the file; and
a storage controller configured to receive the key-value object from the host and control the non-volatile memory based on received key-value object,
wherein the storage controller is further configured to index the key-value object and support a transaction for the key-value objects.
